(19) United States
(12) Patent Application Publication
(10) Pub. No.: US 2018/0341159 A1
(43) Pub. Date: Nov. 29, 2018

(54) COA SUBSTRATE AND LIQUID CRYSTAL DISPLAY PANEL

(71) Applicant: SHENZHEN CHINA STAR OPTOELECTRONICS TECHNOLOGY CO., LTD., Shenzhen, Guangdong (CN)

(72) Inventors: Qiming GAN, Shenzhen, Guangdong (CN); Meng WANG, Shenzhen, Guangdong (CN)

(21) Appl. No.: 15/514,181

(22) PCT Filed: Feb. 13, 2017
(86) PCT No.: PCT/CN2017/073331

§ 371 Date: Mar. 24, 2017

(30) Foreign Application Priority Data
Jan. 18, 2017 (CN) 201710033910.3

(51) Int. Cl. G02F 1/1362; G02F 1/1368; G02F 1/1343

(52) U.S. Cl. CPC G02F 1/136286; G02F 1/1368; G02F 2001/13606; G02F 1/13439; G02F 1/134363

(57) ABSTRACT

The present disclosure provides a COA substrate which includes a plurality of thin film transistors arranged in a matrix, a plurality of data lines, and a plurality of scan lines. The data lines intersect perpendicularly with the data lines. Plural gaps are formed in portions of the data lines which intersect with the scan lines. The gaps cross the scan lines. Each of the gaps is connected via a jumper wire. The jumper wire is electrically connected to one of the data lines via through holes. The portions of the data lines which intersect with the scan lines are replaced by the jumper wires in a different layer. A thickness between the jumper wires and the scan lines is increased, and thus parasitic capacitances in the portions are reduced.

### BACKGROUND OF THE INVENTION

### Field of Invention

The present disclosure relates to a liquid crystal display technology field, and more particularly to a COA substrate and a liquid crystal display panel including the COA substrate.

### Description of Prior Art

Displays, such as liquid crystal displays (referred to as LCDs) and organic electroluminescent devices (referred to as OELDs) have become necessities in people's lives. With the increasing of people's demands, in order to improve display quality of a display and avoid problems that a displacement affects an aperture ratio of the display and light leakage occurs when an array substrate and a color filter substrate are assembled, color filter on array (COA) technology in which the color filter substrate and the array substrate are integrated together is developed. The COA technology is to dispose the color filter substrate on the array substrate.

When a pixel density in a panel is increasing, scan lines for pixels are increasing as well. A charging time of each of the pixels is decreased in a period of a frame. RC delays (signal delays) of data lines can be reduced to increase the charging time of each of the pixels. The signal delays are affected by parasitic capacitances of the data lines. Most of conventional in-plane switching (IPS) type liquid crystal panels use the COA technology, and the parasitic capacitances of intersections of the gate lines and the data lines arc large. Accordingly, the signal delays are increased, and the effective charging time of each of the pixels is reduced, so that the display effect of the liquid crystal display panel is affected.

### SUMMARY OF THE INVENTION

The present disclosure provides a COA substrate capable of reducing parasitic capacitances between gate lines and data lines for solving the technical problems that the parasitic capacitances of intersections of the gate lines and the data lines are large, signal delays arc increased, effective charging time of each of the pixels is reduced, and display effect of a liquid crystal display panel is affected.

To solve the above-mentioned problems, the present disclosure provides a technical scheme as follows.

A COA substrate provided by the present disclosure includes:

A plurality of thin film transistors arranged in a matrix, each of the thin film transistors including a gate, a source, and a drain;

A plurality of data lines, each of the data lines connected to the source of one of the thin film transistors for transmitting a display data signal to one of pixel units;

A plurality of scan lines intersecting perpendicularly with the data lines to define the pixel units, each of the scan lines connected to the gate of one of the thin film transistors for controlling the gate of the one of the thin film transistors to be turned on or turned off;

A plurality of common electrodes connected to common electrode lines via first through holes, the common electrode lines and the scan lines disposed at a same layer, each of the common electrode lines parallel to and adjacent to a previous one of the scan lines;

A plurality of pixel electrodes, each of the pixel electrodes connected to the drain of one of the thin film transistors, the pixel electrodes and the common electrode alternately disposed at a same layer for generating a horizontal electric field to drive liquid crystal molecules to be rotated; and

A color resist layer for filtering backlight to generate color light,

Plural gaps are formed in portions of the data lines which intersect with the scan lines, the gaps cross the scan lines, two terminals of each of the gaps are connected via a jumper wire, and the jumper wire is electrically connected to one of the data lines via second through holes;

Plural second gaps are formed in portions of the data lines which intersect with the common electrode lines, the gaps cross the common electrode lines, two terminals of each of the second gaps are connected via a second jumper wire, and the second jumper wire is electrically connected to one of the data lines via third through holes.

In accordance with an embodiment of the present disclosure, the jumper wires are made of a molybdenum-titanium (Mo—Ti) alloy material.

In accordance with an embodiment of the present disclosure, the common electrodes and the pixel electrodes are made of a molybdenum-titanium (Mo—Ti) alloy material.

In accordance with an embodiment of the present disclosure, a film structure of the COA substrate includes: a glass substrate; and a gate metal layer, a gate insulating layer, an amorphous silicon layer, a source/drain metal layer, a passivation layer, a color resist layer, and a resin layer sequentially formed on the glass substrate, wherein the common electrodes, the pixel electrodes, and the jumper wires are positioned on the resin layer, and the second through holes penetrate from the resin layer to the source/drain metal layer.

In accordance with an embodiment of the present disclosure, the common electrodes and the common electrodes are comb-shaped electrodes and disposed alternately.

The present disclosure further provides A COA substrate, including:

A plurality of thin film transistors arranged in a matrix, each of the thin film transistors including a gate, a source, and a drain;

A plurality of data lines, each of the data lines connected to the source of one of the thin film transistors for transmitting a display data signal to one of pixel units;

A plurality of scan lines intersecting perpendicularly with the data lines to define the pixel units, each of the scan lines connected to the gate of one of the thin film transistors for controlling the gate of the one of the thin film transistors to be turned on or turned off;

A plurality of common electrodes connected to common electrode lines via first through holes, the common electrode lines and the scan lines disposed at a same layer, each of the common electrode lines parallel to and adjacent to a previous one of the scan lines;

A plurality of pixel electrodes, each of the pixel electrodes connected to the drain of one of the thin film transistors, the pixel electrodes and the common electrode alternately disposed at a same layer for generating a horizontal electric field to drive liquid crystal molecules to be rotated; and

A color resist layer for filtering backlight to generate color light,

Plural gaps are formed in portions of the data lines which intersect with the scan lines, the gaps cross the scan lines, two terminals of each of the gaps are connected via a jumper wire, and the jumper wire is electrically connected to one of the data lines via second through holes.

In accordance with an embodiment of the present disclosure, the jumper wires are made of a molybdenum-titanium (Mo—Ti) alloy material.

In accordance with an embodiment of the present disclosure, the common electrodes and the pixel electrodes are made of a molybdenum-titanium (Mo—Ti) alloy material.

In accordance with an embodiment of the present disclosure, a film structure of the COA substrate includes: a glass substrate; and a gate metal layer, a gate insulating layer, an amorphous silicon layer, a source/drain metal layer, a passivation layer, a color resist layer, and a resin layer sequentially formed on the glass substrate, wherein the common electrodes, the pixel electrodes, and the jumper wires are positioned on the resin layer, and the second through holes penetrate from the resin layer to the source/drain metal layer.

In accordance with an embodiment of the present disclosure, the common electrodes and the common electrodes are comb-shaped electrodes and disposed alternately.

In accordance with the above-mentioned objective of the present disclosure, a COA liquid crystal display panel is provided and includes:

An upper substrate having a black matrix manufactured thereon for shielding light from edges of pixel units and interval areas between two adjacent ones of the pixel units;

A lower substrate disposed corresponding to the upper substrate; and

A liquid crystal layer positioned between the upper substrate and the lower substrate.

The low substrate includes:

A plurality of thin film transistors arranged in a matrix, each of the thin film transistors including a gate, a source, and a drain;

A plurality of data lines, each of the data lines connected to the source of one of the thin film transistors for transmitting a display data signal to one of pixel units;

A plurality of scan lines intersecting perpendicularly with the data lines to define the pixel units, each of the scan lines connected to the gate of one of the thin film transistors for controlling the gate of the one of the thin film transistors to be turned on or turned off;

A plurality of common electrodes connected to common electrode lines via first through holes, the common electrode lines and the scan lines disposed at a same layer, each of the common electrode lines parallel to and adjacent to a previous one of the scan lines;

A plurality of pixel electrodes, each of the pixel electrodes connected to the drain of one of the thin film transistors, the pixel electrodes and the common electrode alternately disposed at a same layer for generating a horizontal electric field to drive liquid crystal molecules to be rotated; and

A color resist layer for filtering backlight to generate color light,

Plural gaps are formed in portions of the data lines which intersect with the scan lines, the gaps cross the scan lines, two terminals of each of the gaps are connected via a jumper wire, and the jumper wire is electrically connected to one of the data lines via second through holes.

In accordance with an embodiment of the present disclosure, the jumper wires are made of a molybdenum-titanium (Mo—Ti) alloy material.

In accordance with an embodiment of the present disclosure, the common electrodes and the pixel electrodes are made of a molybdenum-titanium (Mo—Ti) alloy material.

In accordance with an embodiment of the present disclosure, a film structure of the lower substrate includes: a glass substrate; and a gate metal layer, a gate insulating layer, an amorphous silicon layer, a source/drain metal layer, a passivation layer, a color resist layer, and a resin layer sequentially formed on the glass substrate, wherein the common electrodes, the pixel electrodes, and the jumper wires are positioned on the resin layer, and the second through holes penetrate from the resin layer to the source/drain metal layer.

In accordance with an embodiment of the present disclosure, plural second gaps are formed in portions of the data lines which intersect with the common electrode lines, the gaps cross the common electrode lines, two terminals of each of the second gaps are connected via a second jumper wire, and the second jumper wire is electrically connected to one of the data lines via third through holes.

In accordance with an embodiment of the present disclosure, the common electrodes and the common electrodes are comb-shaped electrodes and disposed alternately.

In the COA substrate provided by the present disclosure, the gaps are formed in the portions of the data lines which intersect with the scan lines, and the jumper wires are disposed on the substrate to connect the gaps. A film thickness between the jumper wires and the scan lines is increased, thereby reducing parasitic capacitances of the portions of the data lines which intersect with the scan lines, decreasing signal delays, and increasing an effective charging time of the pixels. Accordingly, the display effect of the liquid crystal display panel is improved.

### BRIEF DESCRIPTION OF THE DRAWINGS

For a better understanding of embodiments or technical schemes in the prior art, the drawings of the embodiments or the description of prior art are briefly described as follows. The drawings in the following descriptions are merely some embodiments of the present disclosure. A person skilled in the art could derive other drawings in accordance with the accompanying drawings without devoting creative work.

FIG. 1 is a structural diagram of a pixel unit on a COA substrate in accordance with the present disclosure.

FIG. 2 is a structural diagram of another pixel unit on a COA substrate in accordance with the present disclosure.

FIG. 3 is a film structure of a COA substrate in accordance with the present disclosure.

### DETAILED DESCRIPTION OF THE PREFERRED EMBODIMENTS

For a better understanding of the aforementioned content of the present disclosure, preferable embodiments are illustrated in accordance with the attached figures for further explanation. The following embodiments are referring to the accompanying drawings for exemplifying specific implementable embodiments of the present disclosure. Furthermore, directional terms described by the present disclosure, such as upper, lower, front, back, left, right, inner, outer, side and etc., are only directions by referring to the accompanying drawings, and thus the used directional terms are used to describe and understand the present disclosure, but the present disclosure is not limited thereto. In the drawings, structure-like elements are labeled with like reference numerals.

The present disclosure aims to solve the technical problems that display effect of a liquid crystal display panel is affected because parasitic capacitances of intersections of gate lines and data lines are large, signal delays are increased, and the effective charging time of each of pixels are reduced.

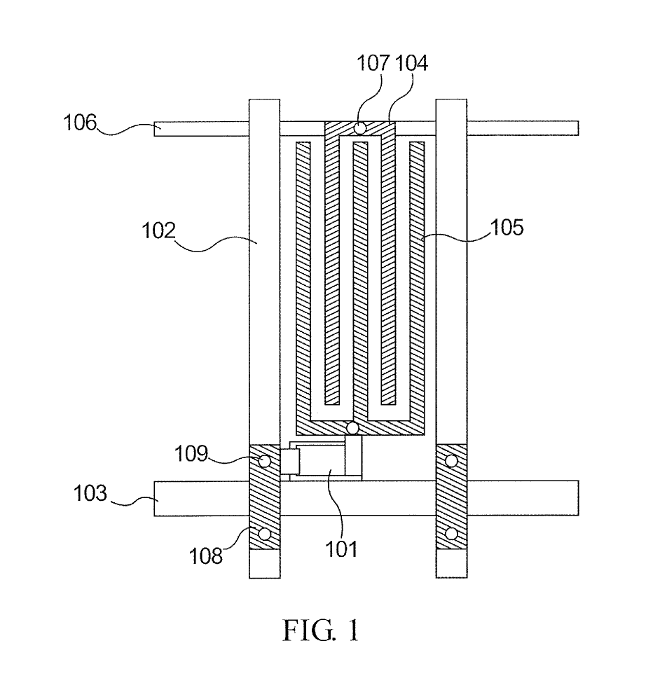

FIG. 1 is a structural diagram of a pixel unit on a COA substrate in accordance with the present disclosure.

A thin film transistor 101, a data line 102, a scan line 103, a common electrode 104, and a pixel electrode 105 are shown in FIG. 1. Plural data lines 102 intersect perpendicularly with plural scan lines 103 to define plural pixel units. The thin film transistor 101 includes a gate, a source, and a drain. The gate of the thin film transistor 101 is connected to the scan line 103. The source of the thin film transistor 101 is connected to the data line 102. The drain of the thin film transistor 101 is connected to the pixel electrode 105. Each of the pixel units has a corresponding common electrode 104. One terminal of the common electrode 104 is connected to a common electrode line 106 via a first through hole 107. The common electrode line 106 and the scan line 103 are disposed at a same layer. The common electrode line 106 is parallel to and adjacent to a previous scan line 103. The common electrode 104 and the pixel electrode 105 are comb-shaped electrodes. The common electrode 104 and the pixel electrode 105 are disposed alternately. Preferably, the common electrode 104, the pixel electrode 105, and a jumper wire 108 are made of a molybdenum-titanium (Mo—Ti) alloy material.

In FIG. 1, plural gaps are formed on the data line 102. The gaps are distributed above the scan line 103, and the gaps are connected via the jumper wire 108. Two terminals of the jumper wire 108 bridge the scan line 103. The two terminals of the jumper wire 108 are electrically connected to the data line 103 via second through holes 109.

In a film structure of the COA substrate, a metal layer on which the data line 102 is located is positioned above a metal layer on which the scan line 103 is located. A passivation layer, a color resist layer, and a resin layer are sequentially formed on the data line 102. The jumper wire 108 is formed on the resin layer on the top. Accordingly, a film thickness between a layer, on which the jumper wire 108 is located, and the metal layer, on which the scan line 103 is located, is larger than a film thickness between the layer, on which the jumper wire 108 is located, and the metal layer, on which the data line 102 is located. This equals to that an interval distance of an overlapping portion between the data line 102 and the scan line 103 is increased, thereby reducing a parasitic capacitance between the data line 102 and the gate line 103, decreasing a signal delay, and increasing an effective charging time of each of the pixels.

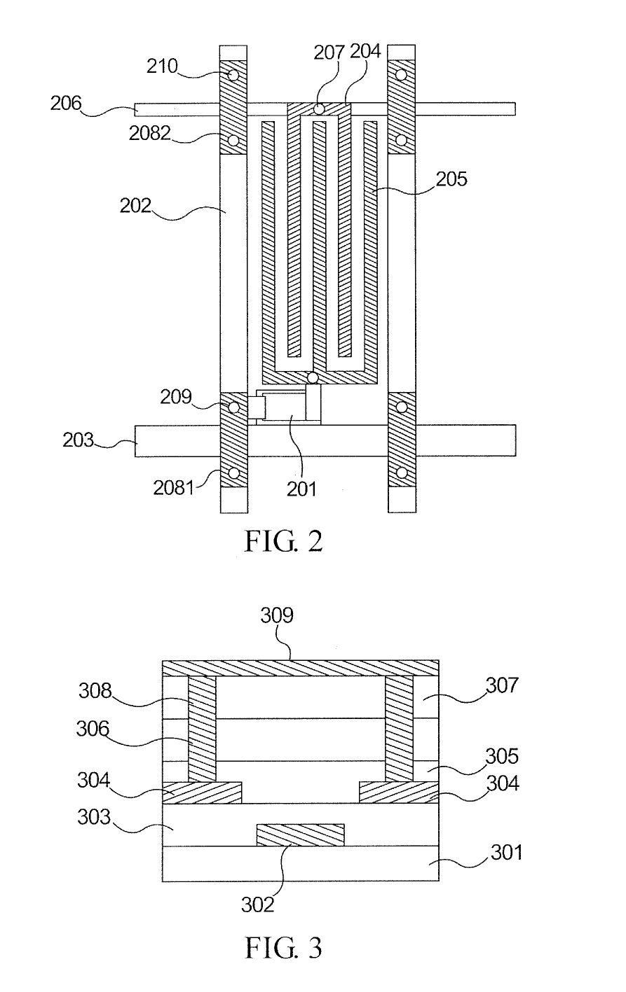

FIG. 2 is a structural diagram of another pixel unit on a COA substrate in accordance with the present disclosure.

A thin film transistor 201, a data line 202, a scan line 203, a common electrode 204, and a pixel electrode 205 are shown in FIG. 2. Plural data lines 202 intersect perpendicularly with plural scan lines 203 to define plural pixel units. The thin film transistor 201 includes a gate, a source, and a drain. The gate of the thin film transistor 201 is connected to the scan line 203. The source of the thin film transistor 201 is connected to the data line 202. The drain of the thin film transistor 201 is connected to the pixel electrode 205. Each of the pixel units has a corresponding common electrode 204. One terminal of the common electrode 204 is connected to a common electrode line 206 via a first through hole 207. The common electrode line 206 and the scan line 203 are disposed at a same layer. The common electrode line 206 is parallel to and adjacent to a previous scan line 203. The common electrode 204 and the pixel electrode 205 are comb-shaped electrodes. The common electrode 204 and the pixel electrode 205 are disposed alternately.

In FIG. 2, plural gaps are formed on the data line 202. The gaps are distributed above the scan line 203 and the common electrode line 206, and the gaps are connected via the jumper wire. The jumper wire includes a first jumper wire 2081 bridging the scan line 103 and a second jumper wire 2082 bridging the common electrode line 206. Two terminals of the first jumper wire 2081 are electrically connected to the data line 202 via second through holes 209. Two terminals of the second jumper wire 2082 are electrically connected to the data line 202 via third through holes 210.

As such, an overlapping portion between the data line 202 and the common electrode line 206 are connected via the second jumper wire 2082, thereby reducing a parasitic capacitance between the data line 202 and a metal line on the substrate and decreasing a signal delay. A liquid crystal display panel has better display effect.

FIG. 3 is a film structure of a COA substrate in accordance with the present disclosure.

As shown in FIG. 3, a glass substrate 301 is provided. A first metal layer is manufactured on the glass substrate 301. A gate of a thin film transistor and a scan line 302 are formed via a first mask. The scan line 302 is connected to the gate of the thin film transistor. Then, a gate insulating layer 303 is manufactured on the glass substrate 301, and a second metal layer is manufactured on the gate insulating layer 303. A source and a drain of the thin film transistor, a data line 304, and gaps formed on the data line 304 are manufactured via a second mask. The data line 304 is connected to the source of the thin film transistor. Then, a passivation layer 305 is manufactured on the glass substrate 301. A color resist layer 306 is manufactured on the passivation layer 305. A resin layer 307 is manufactured on the color resist layer 306.

When the resin layer 307 is manufactured completely, second through holes 308 which penetrate through the resin layer 307 and the passivation layer 305 are formed via the second mask. Finally, a jumper wire 309 is manufactured on the resin layer 307. The jumper wire 309 is positioned above the scan line 302 and crosses the scan line 302. Two terminals of the jumper wire 309 are electrically connected to the data line 304 via the second through holes 308. The resin layer 307 is a polyfluoroalkoxy (PFA) layer.

In the film structure of the COA substrate, the data line 304 does not overlap with the scan line 302, and the jumper wire 309 is manufactured to replace the data line 304 which does not overlap with the scan line 302. This equals to that the data line 304 which does not overlap with the scan line 302 moves up. As a result, a distance between the data line 304 and the scan line 302 is increased, and a parasitic capacitance is reduced.

Preferably, the jumper wire 309 is made of a molybdenum-titanium (Mo—Ti) alloy material, and thus the data line 304 has a better electrical conductivity.

In accordance with the above-mentioned objective of the present disclosure, a COA liquid crystal display panel is provided. The COA liquid crystal display panel includes an upper substrate having a black matrix manufactured thereon for shielding light from edges of pixel units and interval areas between two adjacent ones of the pixel units; a lower substrate disposed corresponding to the upper substrate; and a liquid crystal layer positioned between the upper substrate and the lower substrate. The lower substrate includes a plurality of thin film transistors arranged in a matrix, a plurality of data lines, a plurality of scan lines, a plurality of common electrodes, a plurality of pixel electrodes, and a color resist layer. Each of the thin film transistors includes a gate, a source, and a drain. Each of the data lines is connected to the source of one of the thin film transistors for transmitting a display data signal to one of the pixel units. The scan lines intersect perpendicularly with the data lines to define the pixel units. Each of the scan lines is connected to the gate of one of the thin film transistors for controlling the gate of the one of the thin film transistors to be turned on or turned off. The common electrodes are connected to common electrode lines via first through holes. The common electrode lines and the scan lines are disposed at a same layer. Each of the common electrode lines is parallel to and adjacent to a previous one of the scan lines. Each of the pixel electrodes is connected to the drain of one of the thin film transistors. The pixel electrodes and the common electrode arc alternately disposed at a same layer for generating a horizontal electric field to drive liquid crystal molecules to be rotated. The color resist layer is utilized for filtering backlight to generate color light. Plural gaps are formed in portions which are intersected by the data lines and the scan lines. The gaps cross the scan lines. Two terminals of each of the gaps are connected via a jumper wire. The jumper wire is electrically connected to one of the data lines via second through holes.

In the COA substrate provided by the present disclosure, the gaps are formed in the portions of the data lines which intersect with the scan lines, and the jumper wires are disposed on the substrate to connect the gaps. A film thickness between the jumper wires and the scan lines is increased, thereby reducing parasitic capacitances of the portions of the data lines which intersect with the scan lines, decreasing signal delays, and increasing an effective charging time of the pixels. Accordingly, the display effect of the liquid crystal display panel is improved.

An operating principle of the COA liquid crystal display panel in accordance with the present preferred embodiment is the same as and can be referred to an operating principle of the COA substrate in accordance with the above-mentioned preferred embodiment. The descriptions are not repeated herein.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

1. A COA substrate, comprising:
a plurality of thin film transistors arranged in a matrix, each of the thin film transistors comprising a gate, a source, and a drain;
a plurality of data lines, each of the data lines connected to the source of one of the thin film transistors for transmitting a display data signal to one of pixel units;
a plurality of scan lines intersecting perpendicularly with the data lines to define the pixel units, each of the scan lines connected to the gate of one of the thin film transistors for controlling the gate of the one of the thin film transistors to be turned on or turned off;
a plurality of common electrodes connected to common electrode lines via first through holes, the common electrode lines and the scan lines disposed at a same layer, each of the common electrode lines parallel to and adjacent to a previous one of the scan lines;
a plurality of pixel electrodes, each of the pixel electrodes connected to the drain of one of the thin film transistors, the pixel electrodes and the common electrode alternately disposed at a same layer for generating a horizontal electric field to drive liquid crystal molecules to he rotated; and
a color resist layer for filtering backlight to generate color light,
wherein plural gaps are formed in portions of the data lines which intersect with the scan lines, the gaps cross the scan lines, two terminals of each of the gaps are connected via a jumper wire, and the jumper wire is electrically connected to one of the data lines via second through holes;
plural second gaps are formed in portions of the data lines which intersect with the common electrode lines, the gaps cross the common electrode lines, two terminals of each of the second gaps are connected via a second jumper wire, and the second jumper wire is electrically connected to one of the data lines via third through holes.

2. The COA substrate of claim 1, wherein the jumper wires are made of a molybdenum-titanium (Mo—Ti) alloy material.

3. The COA substrate of claim 1, wherein the common electrodes and the pixel electrodes are made of a molybdenum-titanium (Mo—Ti) alloy material.

4. The COA substrate of claim 1, wherein a film structure of the COA substrate comprises:
a glass substrate; and
a gate metal layer, a gate insulating layer, an amorphous silicon layer, a source/drain metal layer, a passivation layer, a color resist layer, and a resin layer sequentially formed on the glass substrate,
wherein the common electrodes, the pixel electrodes, and the jumper wires are positioned on the resin layer, and the second through holes penetrate from the resin layer to the source/drain metal layer.

5. The COA substrate of claim 1, wherein the common electrodes and the common pixel electrodes are comb-shaped electrodes and disposed alternately.

6. A COA substrate, comprising:
a plurality of thin film transistors arranged in a matrix, each of the thin film transistors comprising a gate, a source, and a drain;
a plurality of data lines, each of the data lines connected to the source of one of the thin film transistors for transmitting a display data signal to one of pixel units;
a plurality of scan lines intersecting perpendicularly with the data lines to define the pixel units, each of the scan lines connected to the gate of one of the thin film transistors for controlling the gate of the one of the thin film transistors to be turned on or turned off;
a plurality of common electrodes connected to common electrode lines via first through holes, the common electrode lines and the scan lines disposed at a same layer, each of the common electrode lines parallel to and adjacent to a previous one of the scan lines;
a plurality of pixel electrodes, each of the pixel electrodes connected to the drain of one of the thin film transistors, the pixel electrodes and the common electrode alternately disposed at a same layer for generating a horizontal electric field to drive liquid crystal molecules to be rotated; and
a color resist layer for filtering backlight to generate color light,
wherein plural gaps are formed in portions of the data lines which intersect with the scan lines, the gaps cross the scan lines, two terminals of each of the gaps are connected via a jumper wire, and the jumper wire is electrically connected to one of the data lines via second through holes.

7. The COA substrate of claim 6, wherein the jumper wires are made of a molybdenum-titanium (Mo—Ti) alloy material.

8. The COA substrate of claim 6, wherein the common electrodes and the pixel electrodes are made of a molybdenum-titanium (Mo—Ti) alloy material.

9. The COA substrate of claim 6, wherein a film structure of the COA substrate comprises:
a glass substrate; and
a gate metal layer, a gate insulating layer, an amorphous silicon layer, a source/drain metal layer, a passivation layer, a color resist layer, and a resin layer sequentially formed on the glass substrate,
wherein the common electrodes, the pixel electrodes, and the jumper wires are positioned on the resin layer, and the second through holes penetrate from the resin layer to the source/drain metal layer.

10. The COA substrate of claim 6, wherein the common electrodes and the pixel electrodes are comb-shaped electrodes and disposed alternately.

11. A COA liquid crystal display panel, comprising:
an upper substrate having a black matrix manufactured thereon for shielding light from edges of pixel units and interval areas between two adjacent ones of the pixel units;
a lower substrate disposed corresponding to the upper substrate; and
a liquid crystal layer positioned between the upper substrate and the lower substrate,
wherein the low substrate comprises:
a plurality of thin film transistors arranged in a matrix, each of the thin film transistors comprising a gate, a source, and a drain;
a plurality of data lines, each of the data lines connected to the source of one of the thin film transistors for transmitting a display data signal to one of pixel units;
a plurality of scan lines intersecting perpendicularly with the data lines to define the pixel units, each of the scan lines connected to the gate of one of the thin film transistors for controlling the gate of the one of the thin film transistors to be turned on or turned off;
a plurality of common electrodes connected to common electrode lines via first through holes, the common electrode lines and the scan lines disposed at a same layer, each of the common electrode lines parallel to and adjacent to a previous one of the scan lines;
a plurality of pixel electrodes, each of the pixel electrodes connected to the drain of one of the thin film transistors, the pixel electrodes and the common electrode alternately disposed at a same layer for generating a horizontal electric field to drive liquid crystal molecules to be rotated; and
a color resist layer for filtering backlight to generate color light,
wherein plural gaps are formed in portions of the data lines which intersect with the scan lines, the gaps cross the scan lines, two terminals of each of the gaps are connected via a jumper wire, and the juniper wire is electrically connected to one of the data lines via second through holes.

12. The COA liquid crystal display panel of claim 11, wherein the jumper wires are made of a molybdenum-titanium (Mo—Ti) alloy material.

13. The COA liquid crystal display panel of claim 11, wherein the common electrodes and the pixel electrodes are made of a molybdenum-titanium (Mo—Ti) alloy material.

14. The COA liquid crystal display panel of claim 11, wherein a film structure of the lower substrate comprises:
a glass substrate; and
a gate metal layer, a gate insulating layer, an amorphous silicon layer, a source/drain metal layer, a passivation layer, a color resist layer, and a resin layer sequentially formed on the glass substrate,
wherein the common electrodes, the pixel electrodes, and the jumper wires are positioned on the resin layer, and the second through holes penetrate from the resin layer to the source/drain metal layer.
